(19) United States
(12) Patent Application Publication
(10) Pub. No.: US 2025/0383848 A1
(43) Pub. Date: Dec. 18, 2025

(54) Parse-Driven Object Configurator

(71) Applicant: Niantic Spatial, Inc., San Francisco, CA (US)

(72) Inventors: Christoph Michael Bartschat, Mountain View, CA (US); Rigel Gareth Benton, Mountain View, CA (US); Jonathan Perrins, San Francisco, CA (US); Dale Ross, San Francisco, CA (US); Jonathan Tran, Mountain View, CA (US); Amanda Whitt, San Francisco, CA (US); Joel Udwin, Mountain View, CA (US); Dat Tan Chu, San Jose, CA (US); Nicholas John Butko, Cupertino, CA (US); Erik Marshall Murphy-Chutorian, Palo Alto, CA (US)

(21) Appl. No.: 19/242,681

(22) Filed: Jun. 18, 2025

Related U.S. Application Data
(60) Provisional application No. 63/661,548, filed on Jun. 18, 2024.

(51) Int. Cl. G06F 8/30

(52) U.S. Cl. CPC G06F 8/37

(57) ABSTRACT

A set of code syntax is parsed to identify relevant resources rather than being executed or compiled. The syntax serves as a domain-specific language in that it can be used only to obtain resources that have been validated and included in the syntax. Developers write code to implement their components in a browser-based development environment. The development environment provides a library of user interface components that may be used and manipulated by developers. The studio parses the developer's code and syntax statements to infer a set of the user interface components that allows other developers to configure these components using the development environment's user interface.

### CROSS REFERENCE TO RELATED APPLICATIONS

This application claims the benefit of U.S. Provisional Application No. 63/661,548, filed June 18, which is incorporated by reference.

### BACKGROUND

### 1. Technical Field

The subject matter described relates generally to browser-based application development tools and, in particular, to using a parser to avoid the need to compile or execute third-party code within a development environment.

### 2. Background Information

In an application development ecosystem, developers may share application content with other developers. One such ecosystem is an augmented reality ecosystem, in which developers may make virtual content items available for other developers to incorporate into their applications. Traditionally, developers share content by providing source code to each other. However, in a browser-based development environment, there are dangers in allowing compilation or execution of third-party code. For example, a malicious actor may include code that, if executed in a browser, uses session tokens to access the executing user's bank accounts or other secure information.

### SUMMARY

The above and other problems may be addressed by using a set of code syntax (e.g., stored in comments) that is parsed to identify relevant resources rather than executed or compiled. The syntax serves essentially as a domain-specific language in that it can be used only to obtain resources that have been validated and included in the syntax. Developers write code to implement their components in a browser-based development environment, also referred to as the studio. The studio provides a library of user interface (UI) components that may be used and manipulated by developers. The studio parses the developer's code and syntax statements to infer a set of the UI components that allows other developers to configure these components using the studio's UI. Because the developer code is parsed outside of the context of the code execution, the danger of compiling or executing the code within the browser is sidestepped. The code itself need not be executed until the completed application is run on an end user device, which does not come with the same risks as executing code within a browser. Since the developers do not directly control the UI being used for configuration, the entity providing the studio can update the UIs independently from the developers' code. This can be particularly useful in an ecosystem where developers share content as it lessens the risk of content obtained from third parties representing a risk to other developers.

### BRIEF DESCRIPTION OF THE DRAWINGS

FIG. 1 is a block diagram of a networked computing environment suitable for browser-based application development, according to one embodiment.

FIG. 2 is a block diagram of the development server of FIG. 1, according to one embodiment.

FIG. 3A illustrates an example application interface with default UI components, according to one embodiment.

FIG. 3B illustrates the example application interface with modified UI components, according to one embodiment.

FIG. 4 is a flowchart of a method for using a parser to identify UI elements without executing or compiling code, according to one embodiment.

FIG. 5 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

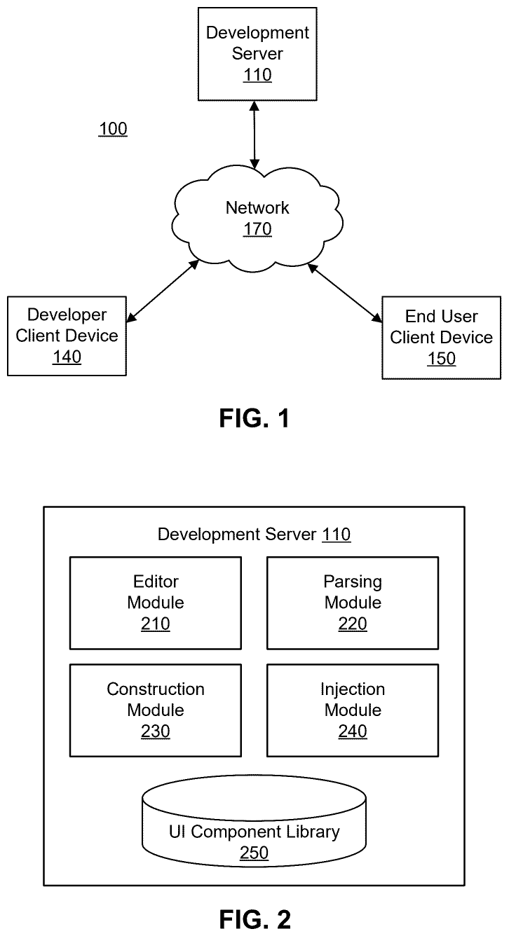

FIG. 1 illustrates one embodiment of a networked computing environment 100 suitable for browser-based application development. In the embodiment shown, the networked computing environment 100 includes a development server 110, a developer client device 140, and an end user client device 150, all connected via a network 170. In other embodiments, the networked computing environment 100 includes different or additional elements. In addition, the functions may be distributed among the elements in a different manner than described.

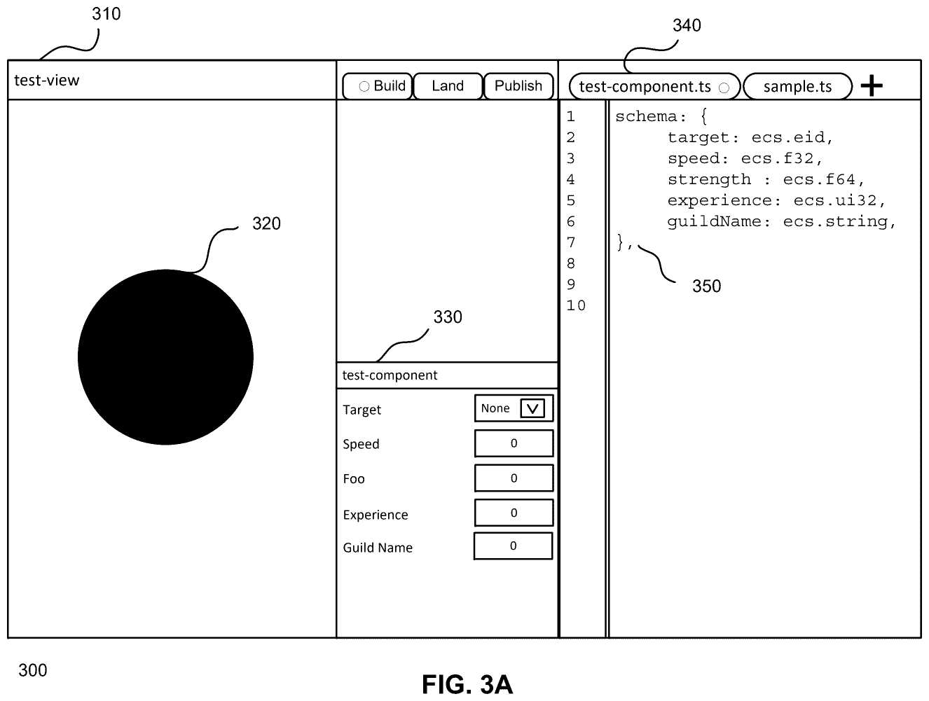

The development server 110 includes one or more computing devices that provide a suite of application development tools, also referred to as the studio, with which developers may create applications. The studio is described being used to create augmented reality applications (e.g., games) that overlay virtual content on images (e.g., a real time video) of the real world, but the disclosed techniques may be applied to development of other types of application. In one embodiment, the studio provides an interface with which a developer can write code including identifying components and properties of those components to include the application using a predefined syntax. The predefined syntax may be stored in non-executable code comments that are not compiled. The studio includes a parser that parser the syntax to identify from a library UI components and properties of those components to include in the application without executing or compiling the code. The application can be built using the identified components and properties which are then injected at run time into the application for an end user's device. Various embodiments of the development server 110 are described in greater detail below, with reference to FIG. 2.

The developer client device 140 is a computing device with which a developer accesses the studio provided by the development server 110. Although a single developer client device 140 is shown for convenience, the networked computing environment 100 can include any number of such devices. In one embodiment, a developer uses an internet browser on the developer client device 140 to access the studio provided by the development server 110. Thus, the developer may develop applications without the need for specialized software to be installed locally. In other embodiments, dedicated software may be installed on the developer client device 140 to access the studio functionality provider by the development server 110.

The end user client device 150 is a computing device with which an end user may use applications developed using the studio. Although a single end user client device 150 is shown for convenience, the networked computing environment 100 can include any number of such devices. In one embodiment, the end user client device 150 is a smart phone or other mobile device that runs an augmented reality application such as parallel reality game that was developed using the studio. Virtual content authored in the studio may be provided for display by the end user client device 150 overlaid onto images (e.g., a video feed) captured by one or more cameras of the end user client device 150.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

### Example Development Server

FIG. 2 illustrates one embodiment of the development server 110. In the embodiment shown, the development server 110 includes an editor module 210, a parsing module 220, a construction module 230, an injection module 240, and a UI component library 250. In other embodiments, the development server 110 includes different or additional elements. In addition, the functions may be distributed among the elements in a different manner than described.

The editor module 210 provides an editor with which a developer may author content. In one embodiment, the content is virtual content for inclusion in an augmented reality application, such as a parallel-reality game. Using the studio, developers can create entities which have components within a scene. Each component has a static set of schema fields holding properties of the component. The values stored in these fields can be changed at runtime with code. The values may be hand edited by the game designers to construct the application. For example, a planet component might have properties like temperature, mass, diameter, and a game designer can construct a set of planets by applying these components with different values onto different entities in the scene.

The studio exposes a set of UI components in a library so these fields can be configured by the designer. Since developers can build any component, the UI elements for all possible components cannot be hardcoded in advance. Because of the security risks in allowing developers to execute or compile code in a browser-based development environment, developers instead identify and define components using non-executable syntax (e.g., in comments associated with their code).

The parsing module 220 parses developer code and identifies which UI component or components from the UI component library 250 are needed. In one embodiment, the developer includes non-executable portions in the code that are not compiled (e.g., comments) according to an established parser syntax. The parser syntax is a mapping of specific strings or other variables that may be included as non-executable, uncompiled code, that are mapped to specific components and properties. For example, a developer may include comments identifying that a planet, moon, and spaceship are required for a scene and the parsing module 220 correlates these comments with specific UI components stored in the UI component library 250. The developer can then configure these components using the studios UI. Because developers do not control the UI being used for configuration of the UI component library 250, these can be updated by the entity that provides the studio independently. For example, a planet UI component could be updated to provide more realistic textures, or provide more configurable parameters, etc.

The construction module 230 takes the developer code and identified UI components and constructs the application in a form that is ready to be provided to end users. In one embodiment, this involves incorporating references to the included UI components from the UI component library 250 without executing the developer's code used to identify or modify the parameters of these UI components within the studio. The constructed application may then be provided to one or more end user client devices 250.

The injection module 240 provides UI components from the UI component library to end user client devices 150 as needed. For example, in one embodiment, when an end user client device executes an application, any necessary UI components and related code are injected into the application and executed at the end user client devices 150. Thus, this code never needs to be executed within the browser-based development environment provided by the studio. Executing this code at the end user client device 150 does not present the same risks as executing it within the studio because it can be included in a stand-alone application that does not have the same access permissions as a typical web browser. For example, a user's bank account details are unlikely to be available to the application at run time whereas they may be obtainable by code that is executed within the user's web browser.

The UI component library 250 includes one or more non-transitory computer-readable media that store the UI components that can be incorporated into applications using the syntax. Although the UI component library 250 is shown as a single element within the development server 110, in some embodiments, the UI components may be stored across multiple devices, such as in a distributed database.

### Example Methods

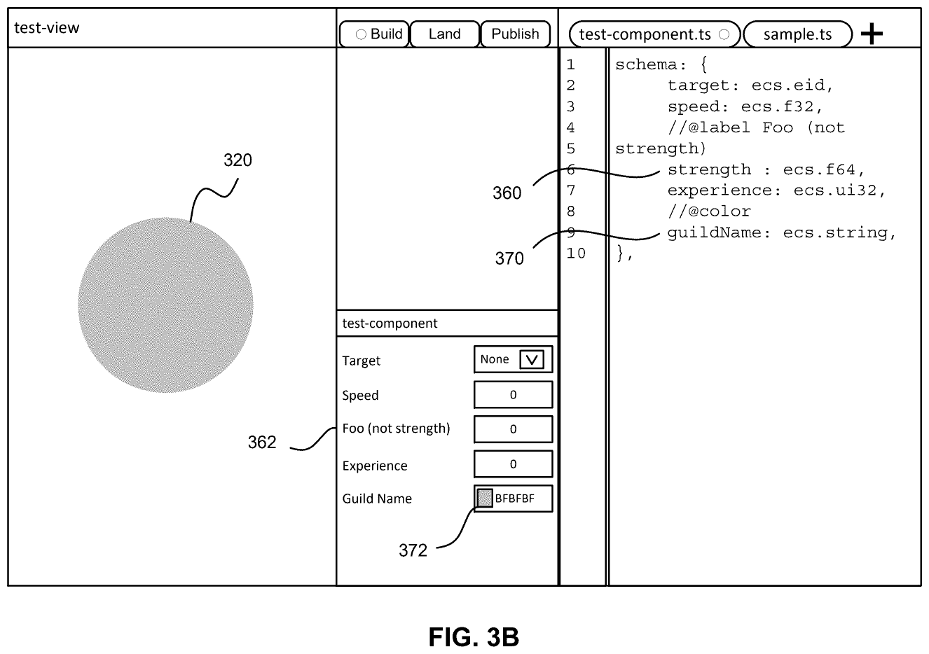

FIG. 3A illustrates an example application interface that includes default UI components, according to the one embodiment. As shown in FIG. 3A, the studio interface 300, provide by the development server 110, enables a developer to access a suite of integrated features for configuring and visualizing application content. Within the studio interface 300, a content visualizer 310 displays the virtual content 320, providing real-time visual representation of the current configuration. The UI components panel 330 reflects the structure defined in the editor 340. It provides interactive controls for each field described in the schema, allowing developers to adjust the components. For example, fields like “Target”, “Speed”, and Experience appear in the panel based on the schema defines in the code from the editor 340. The editor 340 allows the developer to define and modify UI components using code. As shown, files like “test-component.ts” include schema definitions 350 for UI component properties such as target, speed, strength, experience, and guildName. These schema fields may be defined using type declarations from the ECS (Entity Component System) framework, such as ecs.f32 for floating-point values or ecs.string for text. Changes made in the editor 340 directly determine what property values are assigned for the component, impacting what appears in the UI components panel 330. and the rendered output when the virtual content 310 is displayed in the content visualizer 320. An example scenario demonstrating how modifications to component defined by the non-executable, uncompiled code affect the interface and visualization is further illustrated in FIG. 3B.

FIG. 3B illustrates an example application interface with modified UI components, according to one embodiment. As shown in FIG. 3B, the black color of the virtual content 320 has changed to gray. This change results from modifications made in the editor 340, where one or more schema fields 350 are updated using non-executable syntax that is not compiled (e.g., comments). For example, by adding the first non-executable comment 361, //@label Foo (not strength), above a first target component field 360, the studio parses the annotation and updates the corresponding UI component 362. As a result, the label displayed in the UI components panel 330 changes from “strength” to “Foo (not strength).” In another example, the developer modifies a second component field 370 to define the color of the virtual content 320. By adding a second non-executable comment 371, //@color, which triggers a color picker allowing the developer to assign a color value (e.g., #BFBFBF). The UI component 372 reflects the overridden type or value, and the rendered output in the content visualizer 310 updates accordingly to display the gray virtual content 320. Thus, non-executable statements may be used to change the type of a component or the value of a component from the default type or value, respectively.

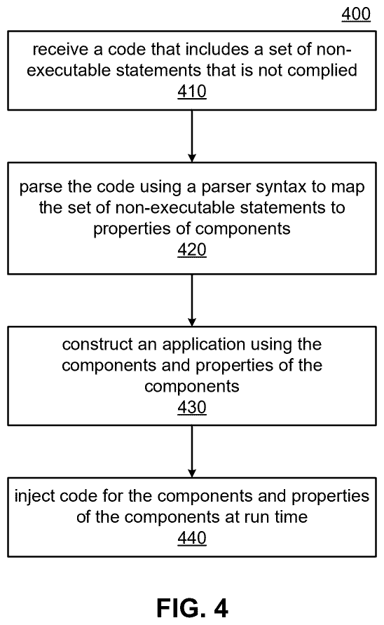

FIG. 4 illustrates a method 400 for a parser to identify UI elements without executing or compiling code, according to one embodiment. The steps of FIG. 4 are illustrated from the perspective of the development server 110 performing the method 400. However, some or all of the steps may be performed by other entities or components. In addition, some embodiments may perform the steps in parallel, perform the steps in different orders, or perform different steps.

In the embodiment shown, the method 400 begins with the development server 110 receiving 410 code for an application that uses the parser syntax. The code may be provided by a developer using a browser-based development environment. The application may be a parallel-reality game that includes augmented reality content. The development server 110 parses 420 the code to identify one or more UI components to include in the augmented reality content and constructs 430 the application using the identified UI components. The application may be constructed 430 without executing the code using the parser syntax within the bowser-based development environment. When the application is run by an end user client device, the code associated with the UI components may be injected into the application, providing the desired functionality defined by the developer's code without that code having been executed or compiled within the development environment.

### Computing System Architecture

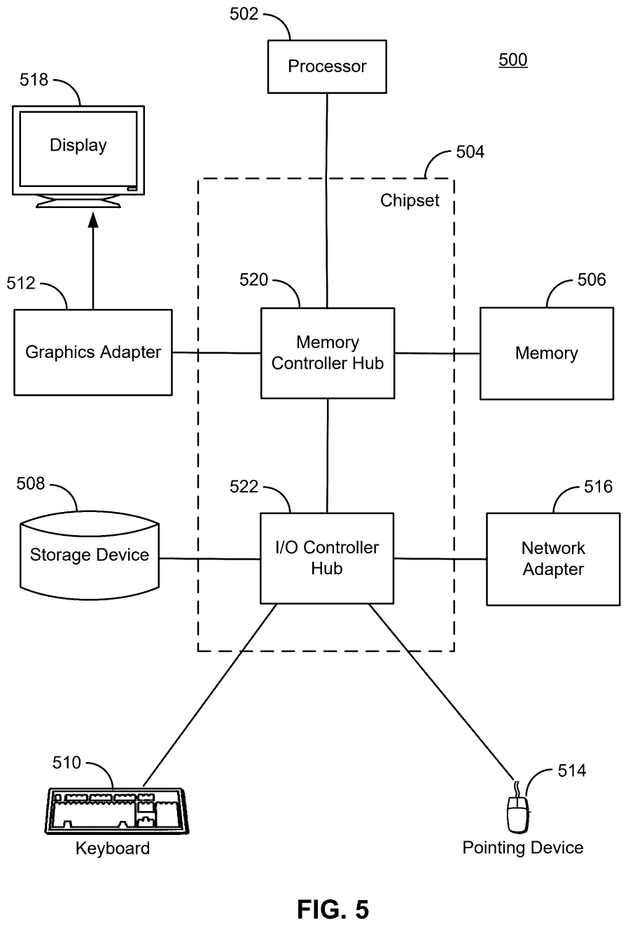

FIG. 5 is a block diagram of an example computer 500 suitable for use as a development server 110, developer client device 140, or end user client device 150. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touchscreen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 and 2 can vary depending upon the embodiment and the processing power required by the entity. For example, the development server 110 might include multiple blade servers working together to provide the functionality described. Furthermore, the computers can lack some of the components described above, such as keyboards 510, graphics adapters 512, and displays 518.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A method comprising:
receiving a code that includes a set of non-executable statements that is not compiled;
parsing the code using a parser syntax to map the set of non-executable statements to components and properties of the components;
constructing an application using the components and properties of the components identified by the set of non-executable statements; and
injecting code for the components and properties of the components at run time.

2. The method of claim 1, wherein the parser syntax uses a predefined library of user interface components.

3. The method of claim 1, wherein the constructing of the application is performed using a browser-based interface configured to display the components identified by the set of non-executable statements.

4. The method of claim 1, wherein the non-executable statements are comments in the code defined by a user within a browser-based interface.

5. The method of claim 1, wherein the properties of a first component of the components are defined in a schema having a set of schema fields.

6. The method of claim 5, wherein a field of the set of schema fields has a default type, and the default type is overridden with a target type by a non-executable statement of the set of non-executable statements.

7. The method of claim 5, wherein a field of the set of schema fields has a default value, and the default value is overridden with a target value by a non-executable statement of the set of non-executable statements.

8. One or more non-transitory computer-readable media storing instructions that, when executed, cause a computing system to perform operations comprising:
receiving a code that includes a set of non-executable statements that is not compiled;
parsing the code using a parser syntax to map the set of non-executable statements to components and properties of the components;
constructing an application using the components and properties of the components identified by the set of non-executable statements; and
injecting code for the components and properties of the components at run time.

9. The one or more non-transitory computer-readable media of claim 8, wherein the parser syntax uses a predefined library of user interface components.

10. The one or more non-transitory computer-readable media of claim 8, wherein the constructing of the application is performed using a browser-based interface configured to display the components identified by the set of non-executable statements.

11. The one or more non-transitory computer-readable media of claim 8, wherein the non-executable statements are comments in the code defined by a user within a browser-based interface.

12. The one or more non-transitory computer-readable media of claim 8, wherein the properties of a first component of the components are defined in a schema having a set of schema fields.

13. The one or more non-transitory computer-readable media of claim 12, wherein a field of the set of schema fields has a default type, and the default type is overridden with a target type by a non-executable statement of the set of non-executable statements.

14. The one or more non-transitory computer-readable media of claim 12, wherein a field of the set of schema fields has a default value, and the default value is overridden with a target value by a non-executable statement of the set of non-executable statements.

15. A computing system comprising:
one or more processors; and
one or more memories storing instructions that, when executed by the one or more processors, cause the computing system to perform operations comprising:
receiving a code that includes a set of non-executable statements that is not compiled;
parsing the code using a parser syntax to map the set of non-executable statements to components and properties of the components;
constructing an application using the components and properties of the components identified by the set of non-executable statements; and
injecting code for the components and properties of the components at run time.

16. The computing system of claim 15, wherein the constructing of the application is performed using a browser-based interface configured to display the components identified by the set of non-executable statements.

17. The computing system of claim 15, wherein the non-executable statements are comments in the code defined by a user within a browser-based interface.

18. The computing system of claim 15, wherein the properties of a first component of the components are defined in a schema having a set of schema fields.

19. The computing system of claim 18, wherein a field of the set of schema fields has a default type, and the default type is overridden with a target type by a non-executable statement of the set of non-executable statements.

20. The computing system of claim 18, wherein a field of the set of schema fields has a default value, and the default value is overridden with a target value by a non-executable statement of the set of non-executable statements.
